(19) United States
(12) Patent Application Publication
(10) Pub. No.: US 2008/0102905 A1
(43) Pub. Date: May 1, 2008

(54) HAND-HELD ELECTRONIC APPARATUS

(75) Inventor: Min-Che Kao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/930,148

(22) Filed: Oct. 31, 2007

(30) Foreign Application Priority Data
Oct. 31, 2006 (TW) 95140132

(51) Int. Cl. H04M 1/00

(52) U.S. Cl. 455/575.1

(57) ABSTRACT

A hand-held electronic apparatus including a main body, an elastic fixing element, a display module and a cover is provided. The elastic fixing element is provided at the main body, and the display module having a display area is provided at the elastic fixing element. Furthermore, the cover is assembled at the main body and covers the display module. The cover has an opening and a plurality of guiding portions provided around the opening. The guiding portions are used to locate the display module to expose the display area by the opening.

### CROSS-REFERENCE TO RELATED APPLICATION

This application claims the priority benefit of Taiwan application serial no. 95140132, filed on Oct. 31, 2006. All disclosure of the Taiwan application is incorporated herein by reference.

1. Field of the Invention

The invention relates to an electronic apparatus and, more particularly, to a hand-held electronic apparatus.

2. Description of the Related Art

With the improvement of the electronic and communicational technology, hand-held electronic apparatuses such as mobile phones have been essential communication tools in people's life. FIG. 1A is an exploded diagram showing a conventional hand-held electronic apparatus. FIG. 1B is a combined diagram showing the hand-held electronic apparatus shown in FIG. 1A. Please refer to FIG. 1A and FIG. 1B simultaneously. The conventional hand-held electronic apparatus 100 mainly includes a main body 110, a display module 120, a fixing frame 130 and a cover 140. In the conventional technology, the fixing frame 130 can fix the display module 120 at the main body 110 via a plurality of fasteners 150. Thus, the display module 120 can be held between the fixing frame 130 and the main body 110 steadily. In addition, the cover covers the main body 110 and the display module 120 to protect the electronic elements in the main body 110 and display module 120 from damage caused by the external force. The cover 140 has an opening 142 to enable the user to watch the display area 122 of the display module 120.

However, in the conventional technology, since the display module 120 of the hand-held electronic apparatus 100 is fixed at the main body 110 via the fixing frame 130, in the process of assembling the display module 120 to the main body 110, the assembler takes a lot of time to make the display module 120 be held between the main body 110 and the fixing frame 130, and then fixes the display module 120 at the main body 110 via a plurality of fasteners 150. In addition, if the hand-held electronic apparatus 100 is damaged and needs repairing, repairman costs more time to disassemble the fixing frame 130 to make the display module 120 separate from the main body 110. In other words, using the fixing frame 130 to fix the display module 120 at the main body 110 reduces the assembly efficiency of the hand-held electronic apparatus 100 and convenience in repairing.

On the other hand, since the manufacturing tolerance exists in the manufacture of the product, when the cover 140 covers the main body 110 and the display module 120, the assembly precision of the cover 140 and the display module 120 is easy to be affected by the manufacturing tolerance and reduces, so that the opening 142 of the cover 140 cannot expose the display area 122 of the display module 120 completely (the display area 122 is easy to be covered by a part of the cover 140). Thus, a user cannot watch the images shown on the display area 122 completely.

### BRIEF SUMMARY OF THE INVENTION

An objective of the invention is to provide a hand-held electronic apparatus which has a preferred assembly and repair efficiency.

Another objective of the invention is to provide a hand-held electronic apparatus which can enable a user to watch images shown by a display module completely.

To obtain the above or other objectives, the invention provides a hand-held electronic apparatus including a main body, an elastic fixing element, a display module and a cover. The elastic fixing element is provided at the main body. The display module is provided at the elastic fixing element and can move via the elasticity of the elastic fixing element. The display module has a display area. Moreover, the cover can be assembled at the main body to cover the display module. The cover has an opening and a plurality of guiding portions. When the cover is being assembled at the main body, the guiding portions can arrange the display module, so that the opening exposes the display area.

In one embodiment of the invention, the elastic fixing element has a limiting frame, and the display module is provided at the limiting frame.

In one embodiment of the invention, the elastic., fixing element has a plurality of locating protrusions, while the main body has a plurality of locating holes, and the locating protrusions are fastened in the locating holes.

In one embodiment, the elastic fixing element has a first part, a second part and a third part being connected between the first part and the second part, wherein the first part and the second part are fixed at the main body, and the display module is fixed at the third part.

In one embodiment of the invention, the first part and the second part are stuck to the main body by glue.

In one embodiment of the invention, the display module is stuck to the third part by glue.

In one embodiment of the invention, the display module has a flexible circuit board electrically connected to the main body.

In one embodiment of the invention, the elastic fixing element is made of rubber.

For the hand-held electronic apparatus of the invention, since the elastic fixing element has a characteristic of elastic deformation, when the cover is being assembled to the main body to cover the display module, the guiding portions of the cover can fine adjust the display module to the opening of the cover via the deformation characteristic of the elastic fixing element, so that a user can watch the images shown by the display module completely. In addition, in the invention, only sticking the display module to the elastic fixing element and assembling the cover to the main body can make the display module be held between the cover and the main body steadily. In other words, the hand-held electronic apparatus has preferred assembly efficiency. Moreover, when the hand-held electronic apparatus is damaged and needs repairing, a repairman can dissemble the hand-held electronic apparatus quickly to repair the damaged part. That is, the hand-held electronic apparatus of the invention has preferred repair efficiency.

These and other features, aspects, and advantages of the present invention will become better understood with regard to the following description, appended claims, and accompanying drawings.

### BRIEF DESCRIPTION OF THE DRAWINGS

FIG. 1A is an explored diagram showing a conventional hand-held electronic apparatus.

FIG. 1B is a combined diagram showing the hand-held electronic apparatus shown in FIG. 1A.

FIG. 2A is an explored diagram showing a hand-held electronic apparatus of one preferred embodiment of the invention.

FIG. 2B is a combined diagram showing the hand-held electronic apparatus shown in FIG. 2A.

FIG. 3 is a schematic diagram showing the cover shown in FIG. 2A from another angle.

FIG. 4 is a schematic diagram showing the elastic fixing element shown in FIG. 2A form another angle.

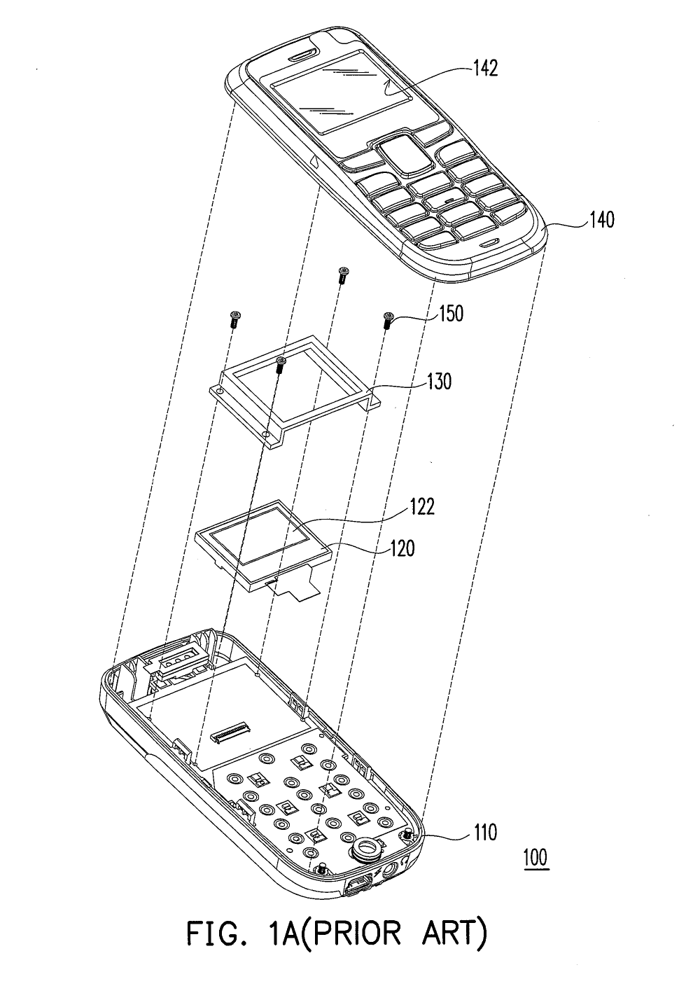

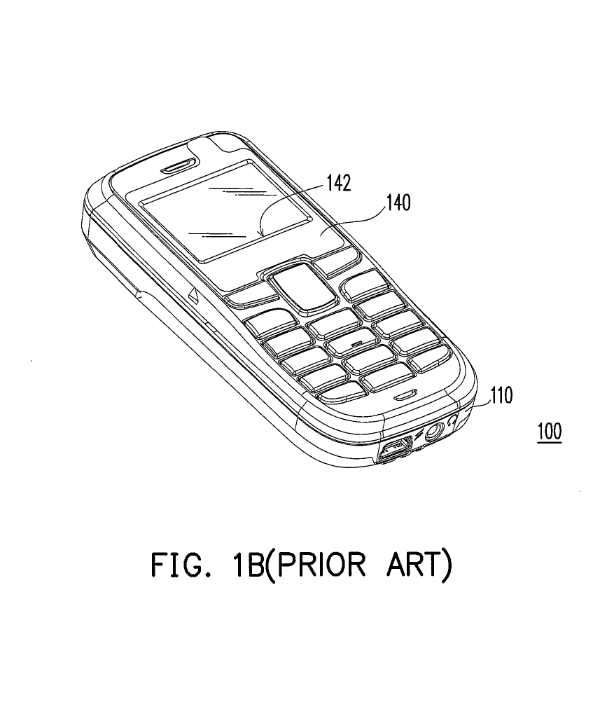

### DETAILED DESCRIPTION OF THE EMBODIMENTS

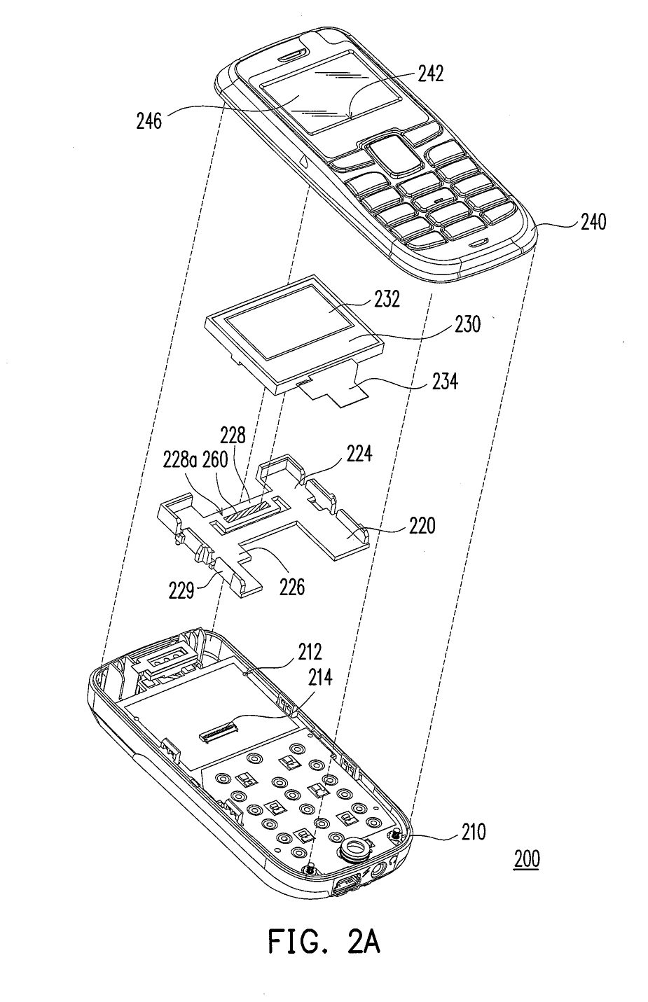

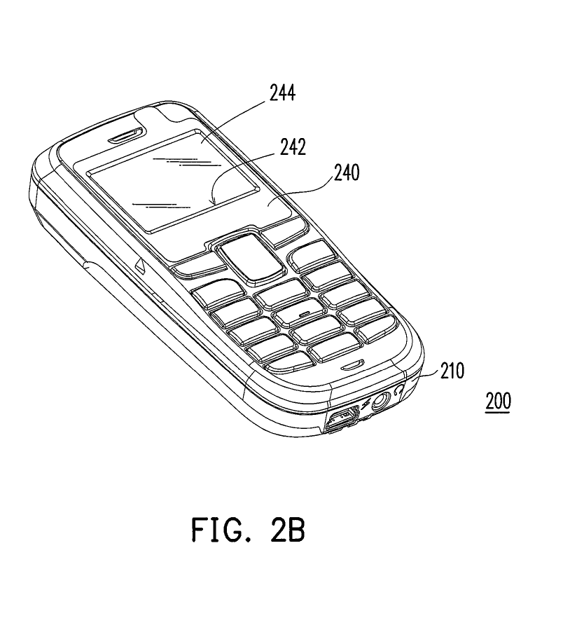

FIG. 2A is an exploded diagram showing a hand-held electronic apparatus of one preferred embodiment of the invention. FIG. 2B is a combined diagram showing a hand-held electronic apparatus shown in FIG. 2A. Please refer to FIG. 2A and FIG. 2B simultaneously. The hand-held electronic apparatus 200 in the embodiment mainly includes a main body 210, an elastic fixing element 220, a display module 230 and a cover 240. In the embodiment, the elastic fixing element 220 made of rubber is provided at the main body 210, and the display module 230 is provided at the elastic fixing element 220, wherein the display module 230 has a display area 232 for people to watch. Moreover, the cover 240 is being assembled at the main body 210 and covers the display module 230. The cover 240 can protect the display module 230 and parts of electronic elements (which are not shown) in the main body 210 from damage caused by external force.

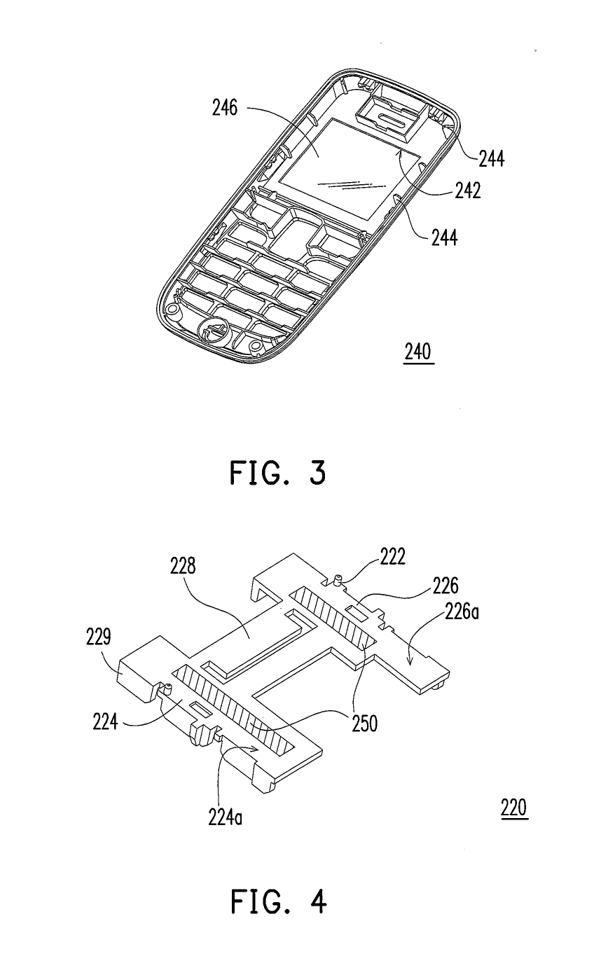

In the embodiment, the cover 240 has an opening 242 and a plurality of guiding portions 244 provided around the opening 242 (Please refer to FIG. 3 which shows the cover shown in FIG. 2A from another angle.), wherein a transparent screen protector 246 is, for example, provided at the opening 242 of the cover 240 to protect the display area 232 from the impact of the external force. In addition, the guiding portions 244 can fine adjust the display module 230 to a proper position, so that the opening 242 can expose the display area 232 completely for a user to watch the images shown by the display area 232.

The constitution structure of the hand-held electronic apparatus 200 is described initially hereinbefore. In the embodiment, the connection relationship between each element of the hand-held electronic apparatus 200 will be described in detail hereinbelow. FIG. 4 is a schematic diagram showing the elastic fixing element shown in FIG. 2A from another angle. Please refer to FIG. 2A and FIG. 4 simultaneously. In the embodiment, the elastic fixing element 220 has, for example, a plurality of locating protrusions 222, and the main body 210 has a plurality of locating holes 212. Thus, the elastic fixing element 220 can be provided at a proper position of the main body 210 by fastening the locating protrusions 222 with the locating holes 212. In addition, the elastic fixing element 220 in the embodiment has a first part 224, a second part 226 and a third part 228 being connected between the first part and the second part. In the embodiment, to make the elastic fixing element 220 be provided on the main body 210 steadily, glue 250 can be stuck to the surface 224a of the first part 224 and the surface 226a of the second part 226, so that the first part 224 and the second part 226 can be fixed at the main body 210 by the glue 250.

From the above, the elastic fixing element 220 in the embodiment also has a limiting frame 229. In the embodiment, since the elastic fixing element 220 has been located at a proper position at the main body 210 by fastening the locating protrusions 222 with the locating hole 212, in the assembly process of display module 230, the display module 230 can be placed in the limiting frame 229 directly, and the complex contraposition process is not needed. In the embodiment, glue 260 can be stuck to the surface 228a of the third part 228, so that the display module 230 provided at the elastic fixing element 220 has a good connection relationship with the third part 228 of the elastic fixing element 220. In the assembly process of the display module 230, the display module 230 provided on the elastic fixing element can be fine adjusted via the deformation characteristic of the elastic fixing element 220.

In one preferred embodiment, the display module 230 has a flexible circuit board 234, and a connecting port 214 is provided on the main body 210, wherein the flexible circuit board 234 is electrically connected to the connecting port 214, and the main body 210 can transmit electrical signals via the electrical connection relationship between the flexible circuit board 234 and the connecting port 214.

In the embodiment, since the elastic fixing element 220 is made of rubber or other proper elastic material, when the cover 240 is being assembled to the main body 210, the guiding portions 244 (as shown in FIG. 3) of the cover 240 can fine adjust the display module 230 stuck to the third part 228 via the characteristic of elastic deformation of elastic fixing element 220 to amend the display module 230 to a proper position, and the opening 242 of the cover 240 can expose the display area 232 of the display module 230 completely. That is, in the embodiment, the assembly precision of the display module can be improved via the characteristic of elastic deformation of the elastic fixing element 220 and the guiding amendment function of the guiding portions 244 (reducing the bad effect made by manufacturing tolerance), so that a user can watch the images displayed by the display area 232 completely from the opening 242 of the cover 240 (images displayed by the display area 232 will not be covered by parts of the cover 240).

To sum up, in the invention, an elastic fixing element is provided on the main body, and the display module is, for example, stuck to the elastic fixing element by glue. In addition, the cover is being assembled at the main body, so that the display module can be held between the elastic fixing element and the cover steadily. The guiding portions of the cover can fine adjust the display module provided on the elastic fixing element to the opening of the cover via the characteristic of elastic deformation of the elastic fixing element, so that a user can watch images shown by the display area completely.

Compared with the conventional technology, in the invention, the display area of the display module can be exposed from the opening of the cover via the characteristic of the elastic deformation of the elastic fixing element and the guiding amendment function of the guiding portions, so that assembly precision can be achieved easily in the invention.

In the invention, easy sticking manner is used to make the display module stick to the elastic fixing element. That is, other assembly tools are not needed to fix the display module in the invention. In other words, the hand-held electronic apparatus of the invention has preferred assembly efficiency. Similarly, when the hand-held electronic apparatus is damaged, after disassembling the cover, a repairman can disassemble the display module from the elastic fixing element easily. That is, the hand-held electronic apparatus of the invention has preferred repair efficiency.

In the invention, since the mold for producing the elastic fixing element has a lower cost, the production cost of the hand-held electronic apparatus is lower.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A hand-held electronic apparatus comprising:
a main body;
an elastic fixing element provided at the main body;
a display module provided at the elastic fixing element and being able to move via elasticity of the elastic fixing element, wherein the display module has a display area; and
a cover assembled at the main body to cover the display module, the cover having an opening and a plurality of guiding portions, wherein when the cover is being assembled at the main body, the display module can be arranged by the guiding portions to expose the display area by the opening.

2. The hand-held electronic apparatus according to claim 1, wherein the elastic fixing element has a limiting frame, and the display module is provided at the limiting frame.

3. The hand-held electronic apparatus according to claim 1, wherein the elastic fixing element has a plurality of locating protrusions, while the main body has a plurality of locating holes, and the locating protrusions are fastened in the locating holes.

4. The hand-held electronic apparatus according to claim 1, wherein the elastic fixing element has a first part, a second part and a third part being connected between the first part and the second part, and the first part and the second part are fixed at the main body, while the display module is fixed at the third part.

5. The hand-held electronic apparatus according to claim 4, wherein the first part and the second part are stuck to the main body by glue.

6. The hand-held electronic apparatus according to claim 4, wherein the display module is stuck to the third part by glue.

7. The hand-held electronic apparatus according to claim 6, wherein the display module has a flexible circuit board electrically connected to the main body.

8. The hand-held electronic apparatus according to claim 1, wherein the elastic fixing element is made of rubber.
